(19) United States
(12) Patent Application Publication
(10) Pub. No.: US 2013/0149463 A1
(43) Pub. Date: Jun. 13, 2013

(54) METHOD OF MANUFACTURING PATTERNED GRAPHENE FILM

(71) Applicants: Feng Zhang, Beijing (CN); Tianming Dai, Beijing (CN); Qi Yao, Beijing (CN)

(72) Inventors: Feng Zhang, Beijing (CN); Tianming Dai, Beijing (CN); Qi Yao, Beijing (CN)

(73) Assignee: BOE TECHNOLOGY GROUP CO., LTD., Beijing (CN)

(21) Appl. No.: 13/805,407

(22) PCT Filed: Aug. 9, 2012
(86) PCT No.: PCT/CN12/79873

§ 371 Date: Dec. 19, 2012

(30) Foreign Application Priority Data
Aug. 12, 2011 (CN) 201110231196.1

(51) Int. Cl. B05D 5/00

(52) U.S. Cl. CPC B05D 5/00
USPC 427/552; 427/282; 427/240; 427/558

(57) ABSTRACT

Embodiments of the invention provide a method of manufacturing a patterned graphene film. The method comprises the following steps: Step 1: a photoresist layer/electron-beam resist layer is coated on a substrate and patterned, the photoresist layer/electron-beam resist layer in a region for forming the patterned graphene film is removed; Step 2: a solution of oxidized graphene is coated on the substrate formed with the photoresist layer/electro-beam resist layer patterned in Step 1, so that a film of oxidized graphene is formed; Step 3: the substrate obtained in Step 2 is placed in a hydrazine steam, so that the film of oxidized graphene formed in Step 2 is reduced and a graphene film is obtained; and Step 4: the photoresist layer/electron-beam resist layer and the graphene film on the photoresist layer/electrone-beam resist layer are removed, so that the patterned graphene film is obtained.

### TECHNICAL FIELD

Embodiments of the invention relate to a method of manufacturing a patterned graphene film.

### BACKGROUND

Graphene is a two-dimensional crystal formed by arranging carbon atoms in a honeycomb-like form. At present, graphene and its related devices have became a research focus in the fields of physics, chemistry, biology and material science due to its quantum transport characteristic, high conductivity, high mobility and high transmittance. Graphene has been used to manufacture various devices such as field-effect transistor, solar cell, nano-generator, sensor and the like.

Graphene film may be obtained by many different methods, such as a mechanical stripping method, a chemical vapor deposition method, a method of thermal decomposition of SiC substrate, a chemical method and the like.

In the mechanical stripping method, an adhesive tape is repeatedly pasted to and peeled off from graphite so as to manufacture the graphene film. In this method, it is difficult to control the size and thickness of the graphene film and merely the graphene film of several square millimeters may be obtained.

In the chemical vapor deposition method, a carbon source such as CH₄ is firstly heated to about 1000V and decomposed in a vacuum chamber, and then the graphene film is obtained on a metal foil of Ni, Cu and the like.

In the method of thermal decomposition of SiC substrate, Si atoms on the surface of the SiC substrate are removed after the SiC substrate is heated to about 1300° C., and then the remaining C atoms spontaneously recombine with each other to form the graphene film.

In the methods described above, it is difficult to obtain large size graphene film, the manufacture temperature is too high and thus the manufacture cost can not be decreased. Therefore, the methods described above are not suitable for industrialization.

In the chemical method, graphite powders are firstly oxidized, the oxidized graphite powders are dissolved to form a solution, and then the resultant solution is coated on a substrate and reduced. This method has a simpler procedure, a lower process temperature, a lower manufacture cost and may form large size graphene film, and thus it is suitable for industrialization.

During manufacturing electronic devices using the grapheme film, the graphene film generally needs to be patterned. At present, the following methods are employed to pattern the graphene film.

1) a patterned catalyst film is prepared and used to grow patterned graphene film, then the patterned graphene film is transferred to a substrate for forming the electronic devices. This method can not precisely provide the patterned graphene film onto the substrate.

2): a graphene film with a large size is transferred to the substrate for forming the electronic devices and then patterned by an etching process. This method may employ an oxygen plasma etching process and this process may generate irradiation damages on the graphene film and other portions of the devices.

3) a stamper is employed to stamp the patterned graphene film onto the substrate for forming the electronic devices. In this method, it is needed to prepare stampers of different patterns in order to form graphene film of different patterns, thus the manufacture cost is high.

From above descriptions, it can be seen that it is necessary to provide a method of manufacturing the patterned graphene film in a simpler manner, with a lower cost and on a larger scale.

### SUMMARY OF THE INVENTION

According to embodiments of the invention, a method of manufacturing a patterned graphene film is provided. The method comprises the following steps: Step 1: a photoresist layer/electron-beam resist layer is coated on a substrate and patterned, the photoresist layer/electron-beam resist layer in a region for forming the patterned graphene film is removed; Step 2: a solution of oxidized graphene is coated on the substrate formed with the photoresist layer/electro-beam resist layer patterned in Step 1, so that a film of oxidized graphene is formed; Step 3: the substrate obtained in Step 2 is placed in a hydrazine steam, so that the film of oxidized graphene formed in Step 2 is reduced and a graphene film is obtained; and Step 4: the photoresist layer/electron-beam resist layer and the graphene film on the photoresist layer/electrone-beam resist layer are removed, so that the patterned graphene film is obtained.

In the method according to the embodiments of the invention, the patterned photoresist layer/electro-beam resist layer is formed on the substrate so as to manufacture the patterned graphene film. This method has a simpler procedure. a lower cost, and more suitable for large-scale production. In addition, this method has no damages on the substrate and thus can be applied to a variety of substrates.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is schematic view showing forming a patterned resist layer on a substrate according to an embodiment of the invention;

FIG. 2 is schematic view showing coating a solution of oxidized graphene onto the substrate to form a film of oxidized graphene according to the embodiment of the invention;

FIG. 3 is a schematic view showing forming a patterned graphene film on the substrate according to the embodiment of the invention; and

FIG. 4 is a flow chart showing a method of manufacturing a patterned graphene film according to an embodiment of the invention.

### DESCRIPTION OF THE EMBODIMENTS

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

Hereinafter, a method of manufacturing a patterned graphene film according to an embodiment of the invention will be described in detail with reference to FIG. 1 to FIG. 4.

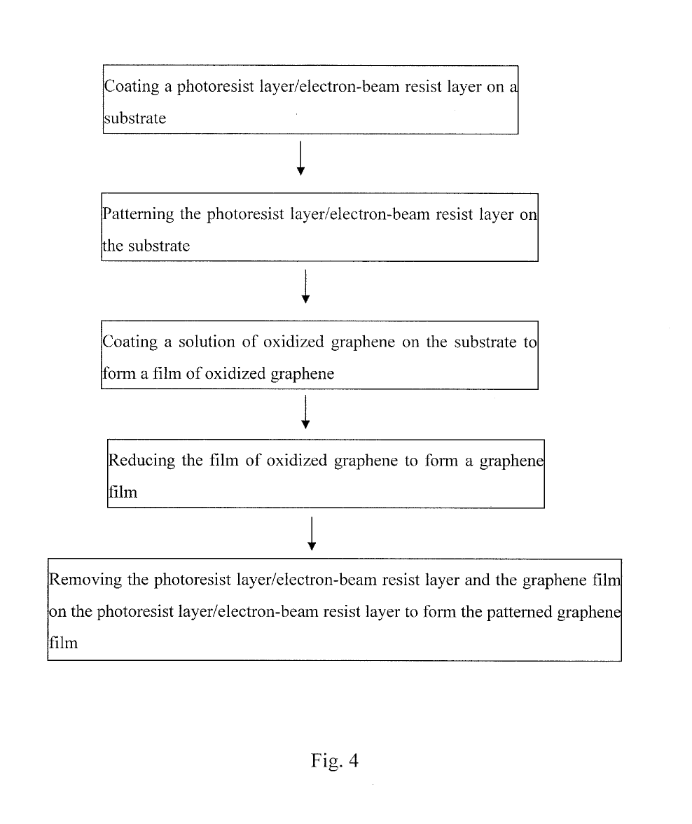

As shown in FIG. 4, the method of manufacturing the patterned graphene film comprises the following steps.

Step 1. a photoresist layer or an electron-beam resist layer 2 is coated on a substrate 1 by a spin-coating method or a blade-coating method, and then patterned by using ultraviolet or electron beam. In this step, the photoresist layer or the electron-beam resist layer in a region for forming the patterned graphene film is removed, as shown in FIG. 1.

Here, the substrate may be formed of glass, metal, quartz, organic film and the like. The organic film may be a PET film, a PS film, a PE film, a PAN film and the like. The photoresist layer or the electron-beam resist layer may have a thickness of 1˜10 μm. The electron-beam resist layer may be formed of PMMA, COP, GeSe, PBS and the like.

Step 2. a solution of oxidized graphene is prepared.

For example, the solution of oxidized graphene may be prepared as follows: under a condition of ice water bath, mixing graphite, sodium nitrate and concentrated sulfuric acid and stirring; slowly adding potassium permanganate; stirring under 25˜40° C. until the resultant solution becomes paste-like; adding de-ionized water and stirring for 10˜30 minutes; adding de-ionized water and aqueous hydrogen peroxide solution and stirring for 10˜30 minutes; filtering the resultant suspending solution and washing by using dilute hydrochloric acid until SO₄²⁻ is removed; washing by using de-ionized water to remove unwanted hydrochloric acid; performing an ultrasonic treatment and then performing a centrifugal treatment to obtain oxidized graphene; dissolving the resultant oxidized graphene into de-ionized water or an organic solvent in different proportions by an ultrasonic method to obtain the solution of oxidized graphene with different concentrations. The organic solvent may be ethanol, acetone, dimethylfomamide, N-methylpyrrdidone, tetrahydrofuran and the like.

It should be noted that, the solution of oxidized graphene is also available in the market.

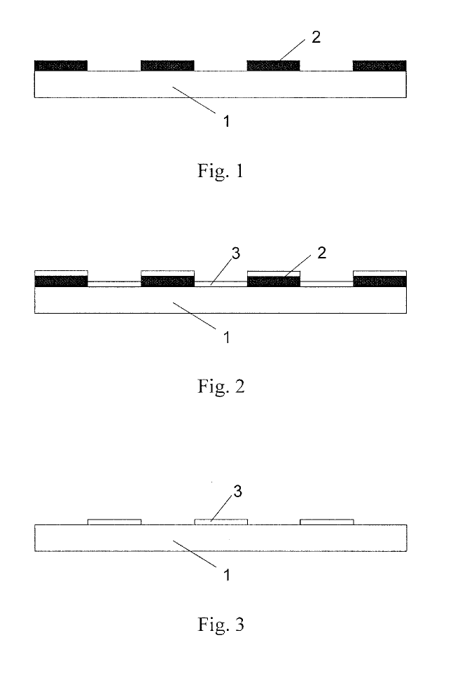

Step 3. the solution of oxidized graphene is coated on the substrate formed with the photoresist layer or electro-beam resist layer patterned in Step 1 by a spin-coating method or a spray-coating method, and then baked under 20˜80° C. to form a film of oxidized graphene, as shown in FIG. 2.

Step 4. an aqueous hydrazine solution is heated to 60˜90° C. to generate a hydrazine steam, and the substrate obtained in Step 3 is placed into an airtight chamber and steamed by the hydrazine steam for 24˜48 hours to reduce the film of oxidized graphene and obtain a graphene film 3.

Step 5. the substrate obtained in Step 4 is immersed into acetone or other stripping solvent for 2˜10 minutes to remove the photoresist layer/electron-beam resist layer and the graphene film on the photoresist layer/electrone-beam resist layer to obtain the patterned graphene film, as shown in FIG. 3.

It should be noted that, the spin-coating method, the blade-coating method and the spray-coating method described above may be performed by conventional equipments and conditions.

### EXAMPLE 1

In the Example 1, the method of manufacturing the patterned graphene film comprises the following steps.

Step 1. a PMMA layer 2 with a thickness of 5 μm is coated on a glass substrate 1 by a spin-coating method, and then patterned by using electron beam. In this step, the PMMA layer in a region for forming the patterned graphene film is removed, as shown in FIG. 1.

Step 2. a solution of oxidized graphene is prepared.

For example, the solution of oxidized graphene is prepared as follows: under a condition of ice water bath, mixing 1 g graphite, 0.25 g sodium nitrate and 11.75 ml concentrated sulfuric acid (98%) in a 200 ml beaker and stirring; slowly adding 1.5 g potassium permanganate; stirring under 35° C. until the resultant solution becomes paste-like; quickly adding 46 ml de-ionized water and stirring for 15 minutes; adding 140 ml de-ionized water and 1.5 ml aqueous hydrogen peroxide solution and stirring for 10 minutes; filtering the resultant suspending solution and washing by using dilute hydrochloric acid until SO₄²⁻ is removed; washing by using de-ionized water to remove unwanted hydrochloric acid; performing an ultrasonic treatment and then performing a centrifugal treatment under a rotating speed of 12000 r/min for 3 minutes to obtain oxidized graphene; dissolving 20 mg oxidized graphene into 100 ml de-ionized water by an ultrasonic method to obtain the solution of oxidized graphene.

Step 3. the solution of oxidized graphene is coated on the substrate formed with the PMMA layer patterned in Step 1 by a spin-coating method, and then baked under 80° C. to form a film of oxidized graphene, as shown in FIG. 2.

Step 4. an aqueous hydrazine solution is heated to 70° C. to generate a hydrazine steam, and the substrate obtained in Step 3 is placed into an airtight chamber and steamed by the hydrazine steam for 48 hours to reduce the film of oxidized graphene and obtain a graphene film 3.

Step 5. the substrate obtained in Step 4 is immersed into acetone for 5 minutes to remove the PMMA layer and the graphene film on the PMMA layer to obtain the patterned graphene film, as shown in FIG. 3.

### EXAMPLE 2

In the Example 2, the method of manufacturing the patterned graphene film comprises the following steps.

Step 1. a positive photoresist layer 2 with a thickness of 10 μm is coated on a substrate 1 formed of PET (polyethylene terephthalate) film by a spin-coating method, and then patterned by using ultraviolet. In this step, the photoresist layer in a region for forming the patterned graphene film is removed, as shown in FIG. 1.

Step 2. a solution of oxidized graphene is prepared.

For example, the solution of oxidized graphene is prepared as follows: under a condition of ice water bath, mixing 1.5 g graphite, 0.35 g sodium nitrate and 11.75 ml concentrated sulfuric acid (98%) in a 200 ml beaker and stirring; slowly adding 2.0 g potassium permanganate; stirring under 40° C. until the resultant solution becomes paste-like; quickly adding 46 ml de-ionized water and stirring for 15 minutes; adding 140 ml de-ionized water and 1.5 ml aqueous hydrogen peroxide solution and stirring for 10 minutes; filtering the resultant suspending solution and washing by using dilute hydrochloric acid until SO₄²⁻ is removed; washing by using de-ionized water to remove unwanted hydrochloric acid; performing an ultrasonic treatment and then performing a centrifugal treatment under a rotating speed of 12000 r/min for 3 minutes to obtain oxidized graphene; dissolving 20 mg oxidized graphene into 100 ml ethanol by an ultrasonic method to obtain the solution of oxidized graphene.

Step 3. the solution of oxidized graphene is coated on the substrate formed with the photoresist layer patterned in Step 1 by a spray-coating method, and then baked under 60° C. to form a film of oxidized graphene, as shown in FIG. 2.

4. an aqueous hydrazine solution is heated to 80° C. to generate a hydrazine steam, and the substrate obtained in Step 3 is placed into an airtight chamber and steamed by the hydrazine steam for 36 hours to reduce the film of oxidized graphene and obtain a graphene film 3.

Step 5. the substrate obtained in Step 4 is immersed into a stripping solvent (SYIC9000 sold by ShangHai XinYang Semiconductor Materials Ltd.) for 10 minutes to remove the photoresist layer and the graphene film on the photoresist layer to obtain the patterned graphene film, as shown in FIG. 3.

### EXAMPLE 3

In the Example 3, the method of manufacturing the patterned graphene film comprises the following steps.

Step 1. a negative photoresist layer 2 with a thickness of 1 μm is coated on a substrate 1 formed of Al foil by a spin-coating method, and then patterned by using ultraviolet. In this step, the photoresist layer in a region for forming the patterned graphene film is removed, as shown in FIG. 1.

Step 2. a solution of oxidized graphene is prepared.

For example, the solution of oxidized graphene is prepared as follows: under a condition of ice water bath, mixing 0.5 g graphite, 0.20 g sodium nitrate and 10.75 ml concentrated sulfuric acid (98%) in a 200 ml beaker and stirring; slowly adding 1.2 g potassium permanganate; stirring under 25° C. until the resultant solution becomes paste-like; quickly adding 46 ml de-ionized water and stirring for 30 minutes; adding 140 ml de-ionized water and 1.5 ml aqueous hydrogen peroxide solution and stirring for 30 minutes; filtering the resultant suspending solution and washing by using dilute hydrochloric acid until SO₄²⁻ is removed; washing by using de-ionized water to remove unwanted hydrochloric acid; performing an ultrasonic treatment and then performing a centrifugal treatment under a rotating speed of 12000 r/min for 3 minutes to obtain oxidized graphene; dissolving 40 mg oxidized graphene into 100 ml de-ionized water by an ultrasonic method to obtain the solution of oxidized graphene.

Step 3. the solution of oxidized graphene is coated on the substrate formed with the photoresist layer patterned in Step 1 by a spray-coating method, and then baked under 20° C. to form a film of oxidized graphene, as shown in FIG. 2.

Step 4. an aqueous hydrazine solution is heated to 90° C. to generate a hydrazine steam, and the substrate obtained in Step 3 is placed into an airtight chamber and steamed by the hydrazine steam for 24 hours to reduce the film of oxidized graphene and obtain a graphene film 3.

Step 5. the substrate obtained in Step 4 is immersed into acetone for 2 minutes to remove the photoresist layer and the graphene film on the photoresist layer to obtain the patterned graphene film, as shown in FIG. 3.

It should be noted that, the materials for forming the substrate, the types of the resist layer, the concentrations of the solution of oxidized graphene are not limited to those listed above, and they can be selected depending on the practical requirements.

It should be appreciated that the embodiments described above are intended to illustrate but not limit the present invention. Although the present invention has been described in detail herein with reference to the preferred embodiments, it should be understood by those skilled in the art that the present invention can be modified and some of the technical features can be equivalently substituted without departing from the spirit and scope of the present invention.

What is claimed is:

1. A method of manufacturing a patterned graphene film, wherein the method comprises the following steps:
Step 1: a photoresist layer/electron-beam resist layer is coated on a substrate and patterned, the photoresist layer/electron-beam resist layer in a region for forming the patterned graphene film is removed;
Step 2: a solution of oxidized graphene is coated on the substrate formed with the photoresist layer/electro-beam resist layer patterned in Step 1, so that a film of oxidized graphene is faulted;
Step 3: the substrate obtained in Step 2 is placed in a hydrazine steam, so that the film of oxidized graphene formed in Step 2 is reduced and a graphene film is obtained; and
Step 4: the photoresist layer/electron-beam resist layer and the graphene film on the photoresist layer/electrone-beam resist layer are removed, so that the patterned graphene film is obtained.

2. The method according to claim 1, wherein in Step 1, the photoresist layer is formed by a positive photoresist or a negative photoresist.

3. The method according to claim 1, wherein in Step 1, the photoresist layer/electron-beam resist layer has a thickness of 1-10 μm.

4. The method according to claim 1, wherein in Step 1, the photoresist layer/electron-beam resist layer is coated on the substrate by a spin-coating method or a blade-coating method.

5. The method according to claim 1, wherein in Step 1, the photoresist layer is patterned by using ultraviolet; while the electron-beam resist layer is patterned by using electron beam.

6. The method according to claim 1, wherein in Step 2, the solution of oxidized graphene is prepared as follows: under a condition of ice water bath, mixing graphite, sodium nitrate and concentrated sulfuric acid and stirring; slowly adding potassium permanganate; stirring under 25˜40° C. until a resultant solution becomes paste-like; adding de-ionized water and stirring for 10˜30 minutes; adding de-ionized water and aqueous hydrogen peroxide solution and stirring for 10˜30 minutes; filtering and then washing by using dilute hydrochloric acid until SO₄²⁻ is removed; washing by using de-ionized water to remove unwanted hydrochloric acid; performing an ultrasonic treatment and then performing a centrifugal treatment to obtain oxidized graphene.

7. The method according to claim 6, wherein the oxidized graphene is dissolved into de-ionized water or an organic solvent in different proportions to obtain the solution of oxidized graphene with different concentrations.

8. The method according to claim 7, wherein the organic solvent is ethanol, acetone, dimethylfomamide, N-methylpyrrdidone or tetrahydrofuran.

9. The method according to claim 1, wherein in Step 2, the solution of oxidized graphene is coated on the substrate by a spin-coating method or a spray-coating method and then is baked under 20˜80° C. to form the film of oxidized graphene.

10. The method according to claim 1, wherein in Step 3, the hydrazine steam is obtained by heating an aqueous hydrazine solution to 60˜90° C.

11. The method according to claim 1, wherein in Step 4, the substrate obtained in Step 3 is immersed into acetone or other stripping solvent to remove the photoresist layer/electron-beam resist layer and the graphene film on the photoresist layer/electrone-beam resist layer.

12. The method according to claim 11, wherein the substrate obtained in Step 3 is immersed into acetone or other stripping solvent for 2˜10 minutes.

13. The method according to claim 1, wherein the substrate is formed of glass, metal, quartz or organic film.

14. The method according to claim 13, wherein the organic film is a PET film, a PS film, a PE film, or a PAN film.
